(19) United States
(12) Patent Application Publication
(10) Pub. No.: US 2018/0092067 A1
(43) Pub. Date: Mar. 29, 2018

(54) System and Method for D2D Communication

(71) Applicant: Futurewei Technologies, Inc., Plano, TX (US)

(72) Inventors: Bin Liu, San Diego, CA (US); Yongbo Zeng, Beijing (CN); Richard Stirling-Gallacher, San Diego, CA (US); Aimin Justin Sang, San Diego, CA (US)

(73) Assignee: Futurewei Technologies, Inc., Plano, TX (US)

(21) Appl. No.: 15/278,896

(22) Filed: Sep. 28, 2016

(51) Int. Cl. H04W 72/04; H04W 76/02

(52) U.S. Cl. CPC H04W 72/04; H04W 72/0486; H04W 76/023

(57) ABSTRACT

A system and method for device-to-device (D2D) communication includes detecting, by a transmitting user equipment (UE) of a plurality of UEs, a sidelink type of a receiving UE of the plurality of UEs, the sidelink type used by the receiving UE to communicate on a discovery channel, determining, by the transmitting UE, a pool of resources for an air interface supported by the receiving UE and the transmitting UE, selecting, by the transmitting UE, transmission resources from the pool of resources according to the sidelink type of the receiving UE, indicating, by the transmitting UE, the transmission resources to the receiving UE over the discovery channel, and communicating, by the transmitting UE, directly with the receiving UE using the transmission resources

### TECHNICAL FIELD

The present invention relates generally to wireless network communications, and, in particular embodiments, to a system and method for device-to-device (D2D) communication.

### BACKGROUND

D2D communication may be used to offer new services, improve system throughput, and offer a better user experience in mobile devices. When performing D2D communication, user equipments (UEs) discover neighboring UEs or other entities. The discovery information is used to perform D2D communication. This information can be used for improving communications performance in various scenarios, personalize advertising, and other applications. Potential use cases for D2D also include proximity-based services (ProSe). As wireless technologies have continued to develop, new challenges in D2D communication are being discovered.

### SUMMARY

In accordance with a preferred embodiment of the present invention, a method includes detecting, by a transmitting user equipment (UE) of a plurality of UEs, a sidelink type of a receiving UE of the plurality of UEs, the sidelink type used by the receiving UE to communicate on a discovery channel, determining, by the transmitting UE, a pool of resources for an air interface supported by the receiving UE and the transmitting UE, selecting, by the transmitting UE, transmission resources from the pool of resources according to the sidelink type of the receiving UE, indicating, by the transmitting UE, the transmission resources to the receiving UE over the discovery channel, and communicating, by the transmitting UE, directly with the receiving UE using the transmission resources.

In accordance with a preferred embodiment of the present invention, a method includes receiving, by a first enhanced base station (eNB), an indicator of a sidelink type for each of a plurality of user equipments (UEs) within range of the first eNB, determining, by the first eNB, a density of the plurality of UEs, and allocating, by the first eNB, one or more resource pools corresponding to air interfaces supported by the plurality of UEs, the one or more resource pools allocated according to the sidelink type of each of the plurality of UEs and the density of the plurality of UEs.

In accordance with a preferred embodiment of the present invention, a transmitting user equipment (UE) includes a processor, and a computer readable storage medium storing programming for execution by the processor, the programming including instructions to detect a sidelink type of a receiving UE of a plurality of UEs, the sidelink type used by the receiving UE to communicate on a discovery channel, determine a pool of resources for an air interface supported by the receiving UE and the transmitting UE, select transmission resources from the pool of resources according to the sidelink type of the receiving UE, indicate the transmission resources to the receiving UE over the discovery channel, and communicate directly with the receiving UE using the transmission resources.

In accordance with a preferred embodiment of the present invention, an enhanced base station (eNB)includes a processor, and a computer readable storage medium storing programming for execution by the processor, the programming including instructions to receive an indicator of a sidelink type for each of a plurality of user equipments (UEs) within range of the eNB, determine a density of the plurality of UEs, and allocate one or more resource pools corresponding to air interfaces supported by the plurality of UEs, the one or more resource pools allocated according to the sidelink type of each of the plurality of UEs and the density of the plurality of UEs.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 shows a network for communicating data;

FIGS. 2A, 2B, and 2C are diagrams showing a network in various configuration for performing D2D discovery and configuration;

FIGS. 3A, 3B, and 3C are sequence diagrams showing D2D configuration methods;

FIGS. 4A and 4B are timing diagrams showing D2D resource selection;

FIG. 5 is a block diagram of a processing system; and

FIG. 6 is a block diagram of a transceiver.

### DETAILED DESCRIPTION OF ILLUSTRATIVE EMBODIMENTS

In fifth-generation (5G) wireless networks, there may be versatile UEs types that cater to different user scenarios. Different UE types may have different UE capabilities. UEs with different capabilities may also have different receiver complexities, power limitations, and the like. Additionally, devices in 5G networks may use different types of air interfaces (AIs) that coexist to meet different application requirements. Different UEs types may support different AIs, or a subset of AIs. Various embodiments allocate D2D communication resources to different AIs for UEs of different types in a same cell, in order to accommodate simultaneous D2D communication over different AIs that may be supported by the different UEs. An AI typically corresponds to a sidelink communications channel type. Embodiments may configure D2D communication on sidelink channels between different UE types in both broadcast and unicast D2D communication.

Techniques for D2D discovery, configuration, and communication are provided in accordance with various embodiments. In particular, a transmit/receive point (TRP) such as an enhanced base station (eNB) or a master UE (sometimes called a “header UE”) collects information about sidelink capabilities and the current sidelink type of UEs within coverage of a cell or a macro cell. The TRP allocates sidelink resource pools for different AIs. The size of the resource pool allocated to each AI depends on the density of UEs within coverage of the cell. The UEs within range may indicate their sidelink type or capabilities through a sidelink channel, such as with a discovery signal in LTE D2D communication. When performing D2D communication in a broadcast scenario, the transmitting UE may select and use AI resources supported by the receiving UEs with the lowest sidelink type or capability in the cell. When performing D2D communication in a unicast scenario, the transmitting UE may select and use AI resources based on the sidelink type or capabilities of the receiving UE.

Embodiments may achieve advantages. Discovery of the sidelink types and capabilities of UEs in coverage of a cell may allow AI resources to be more efficiently allocated to different UEs types when the UEs are performing D2D communication. Further, the UEs may more efficiently select resources from the allocated resource pool when configuring D2D communication.

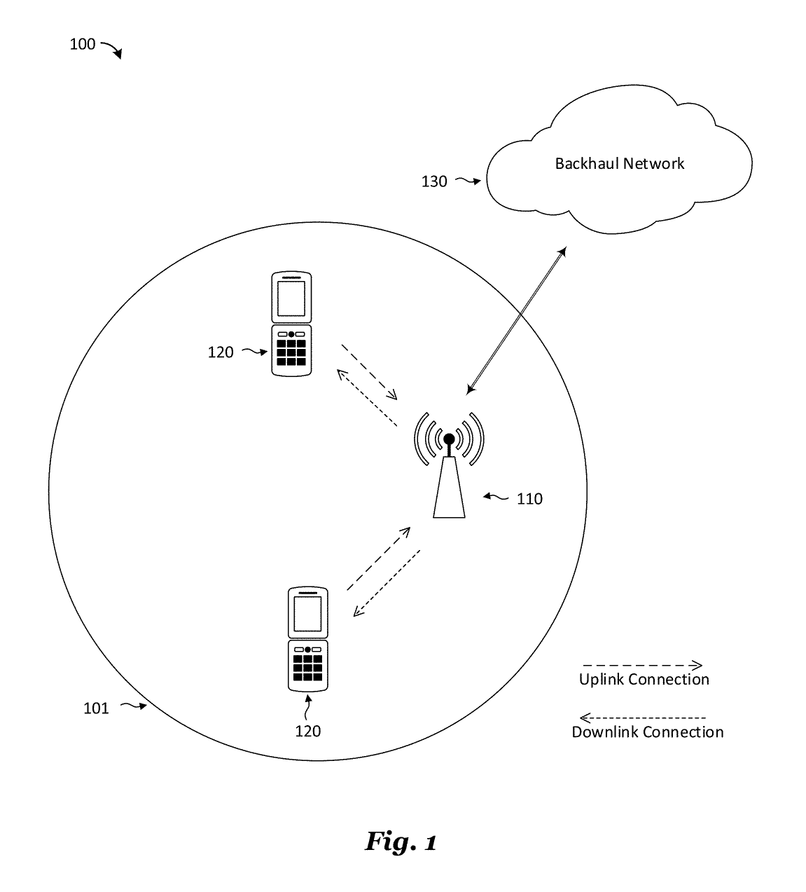

FIG. 1 shows a network 100 for communicating data. The network 100 comprises a base station no having a coverage area 101, a plurality of mobile devices 120, and a backhaul network 130. As shown, the base station no establishes uplink (dashed line) and/or downlink (dotted line) connections with the mobile devices 120, which serve to carry data from the mobile devices 120 to the base station no and vice-versa. Data carried over the uplink/downlink connections may include data communicated between the mobile devices 120, as well as data communicated to/from a remote-end (not shown) by way of the backhaul network 130. As used herein, the term “base station” refers to any component (or collection of components) configured to provide wireless access to a network, such as a TRP, an eNB, a macro-cell, a femtocell, a Wi-Fi access point (AP), or other wirelessly enabled devices. Base stations may provide wireless access in accordance with one or more wireless communication protocols, e.g., long term evolution (LTE), LTE advanced (LTE-A), High Speed Packet Access (HSPA), Wi-Fi 802.11a/b/g/n/ac, etc. As used herein, the term “mobile device” refers to any component (or collection of components) capable of establishing a wireless connection with a base station, such as a user equipment (UE), a mobile station (STA), and other wirelessly enabled devices. In some embodiments, the network 100 may comprise various other wireless devices, such as relays, low power nodes, etc.

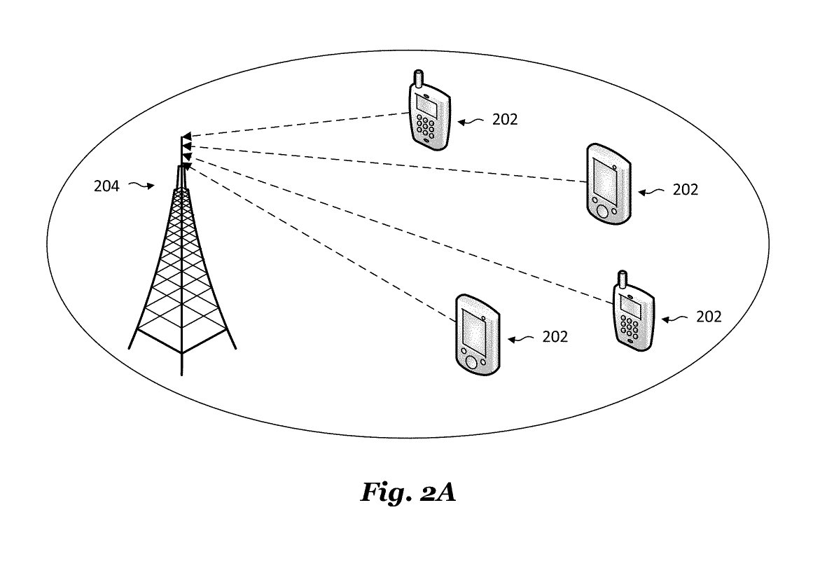

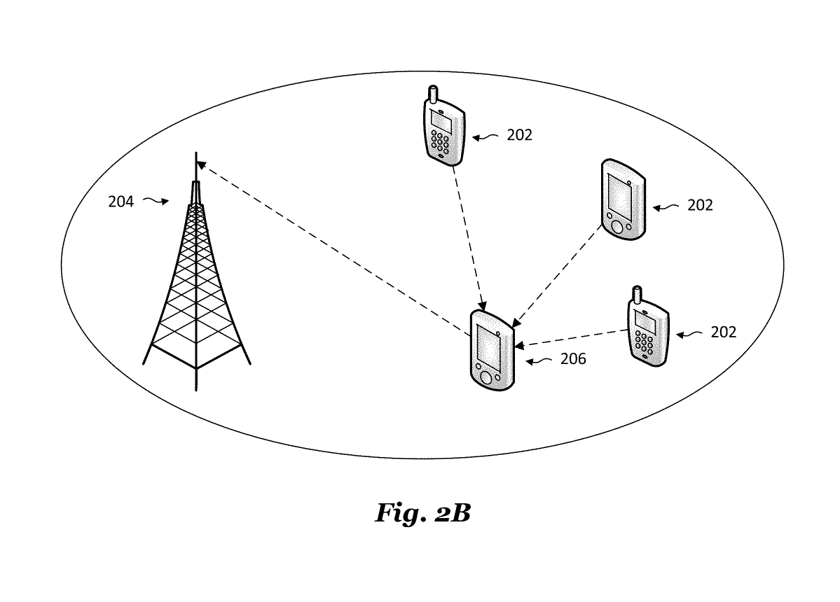

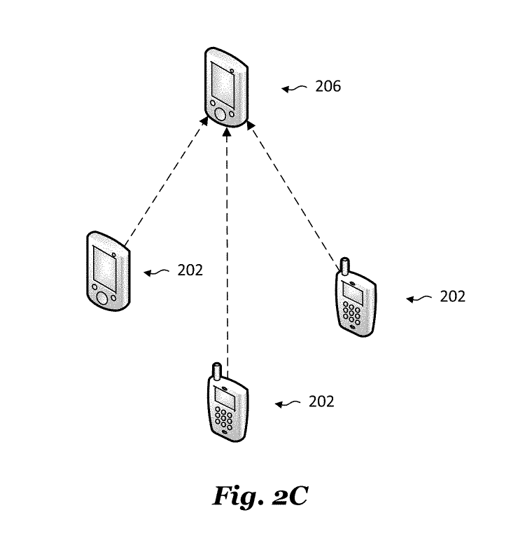

FIGS. 2A, 2B, and 2C are diagrams showing a network in various configuration for performing D2D discovery and configuration. UEs 202 report their current sidelink type and/or sidelink capabilities to a TRP, and that information is then used to perform D2D discovery and configuration. The TRP may be an eNB 204, or a group header 206.

The UEs 202 may be devices that support different air interfaces and/or access schemes, such as 5G devices. The UEs 202 may use the different air interfaces to support different user scenarios. The different air interfaces may be multiplexed, such as in the time and/or frequency domain, and may have configurations that are either dynamic or semi-persistent. For example, the different air interfaces may be controlled with a protocol such as Soft AI, where a UE 202 configures itself to prefer a particular AI, or to adapt to an AI in use by nearby devices. AI configuration may also consider other UE capabilities when allocating resources from a resource pool.

The configuration of the different AIs may be done at the discretion or preference of the UE. In some embodiments, some UE types may prefer certain AIs for sidelink communication, and may prefer certain AIs for uplink/downlink communication. The UE may prefer certain AIs for sidelink communication based on D2D service requirements. For example, the UE may prefer an AI that uses non-orthogonal multiple access technologies for transferring smaller packets in D2D communication, and may prefer an AI that uses orthogonal multiple access technologies for transferring larger packets in D2D communication. The preferred AI, and therefore the current sidelink type, of the UE may also change according to other criteria, such as the time of day, battery level of the UE, and the like.

The UEs 202 may report their sidelink type and/or capabilities using a special messaging format, or may indicate it using a field in an existing discovery channel field. For example, in LTE, reserved bits 3 through 6 in the “Message Type” field of the Physical Sidelink Discovery Channel (PSDCH) may be used to indicate the sidelink type and/or capabilities.

D2D sidelink types may be categorized according to different metrics or technical features that correspond to different AIs. The sidelink type or features needed to support different Ms may be specified in a standard set by a body such as the 3rd Generation Partnership Project (3GPP). For example, a first sidelink type may have features needed to support an orthogonal frequency-division multiple access (OFDMA) AI, a second sidelink type may have features needed to support a sparse code multiple access (SCMA) AI, and a third sidelink type may have features needed to support a non-orthogonal multiple access (NOMA) AI. Alternatively, the sidelink types may be specified in a more generic manner. For example, a first sidelink type may include orthogonal multiple access technologies such as OFDMA or single-carrier frequency domain equalization (SC-FDE), a second sidelink type may include non-orthogonal multiple access technologies such as SCMA or NOMA, and a third sidelink type may include full-power domain multiplexing access technologies.

FIGS. 2A and 2B show the network where the UEs 202 are in coverage of the eNB 204. For in-network coverage scenarios, the eNB 204 collects information about the sidelink type and/or capabilities of the UEs 202. The eNB 204 may be a macro-cell or a microcell. After collecting the information about the sidelink type and/or capabilities of the UEs 202, the eNB 204 allocates sidelink resources to the UEs 202 to use for D2D configuration and communication.

In the embodiment shown in FIG. 2A, the eNB 204 directly collects the sidelink information from the UEs 202. In such embodiments, the eNB 204 is capable of receiving signals on the discovery channel (e.g., PSDCH), and so it directly monitors discovery signals transmitted by the UEs 202 on that channel. In some embodiments, the UEs 202 indicate their sidelink types to the eNB 204 over the Uu link (e.g., the LTE radio interface between the UEs 202 and the eNB 204).

In the embodiment shown in FIG. 2B, the eNB 204 indirectly collects the sidelink information from the UEs 202. In such embodiments, the eNB 204 is not capable of directly receiving discovery channel signals. Instead, another device such as the group header 206 collects the sidelink information from the UEs 202. The group header 206 may then relay that information to the eNB 204 using signaling the eNB 204 supports, such as radio resource control (RRC) signaling. The group header 206 may be one of the UEs 202, or may be another device such as a femtocell or the like.

FIG. 2C shows the network where the UEs 202 are out of coverage of the eNB 204. For out-of-network coverage scenarios, the group header 206 collects information about the sidelink type and/or capabilities of the UEs 202. The group header 206 may collect the information in a manner similar to how the eNB 204 would collect the information in an in-coverage scenario, e.g., by detecting activity of the UEs 202 on the sidelink channels. In such embodiments, the group header 206 then allocates the sidelink resources to the UEs 202 to use for D2D configuration and communication. A transmitting UE 202 may then select a proper AI based on the sidelink types indicated by the other UEs 202 when transmitting.

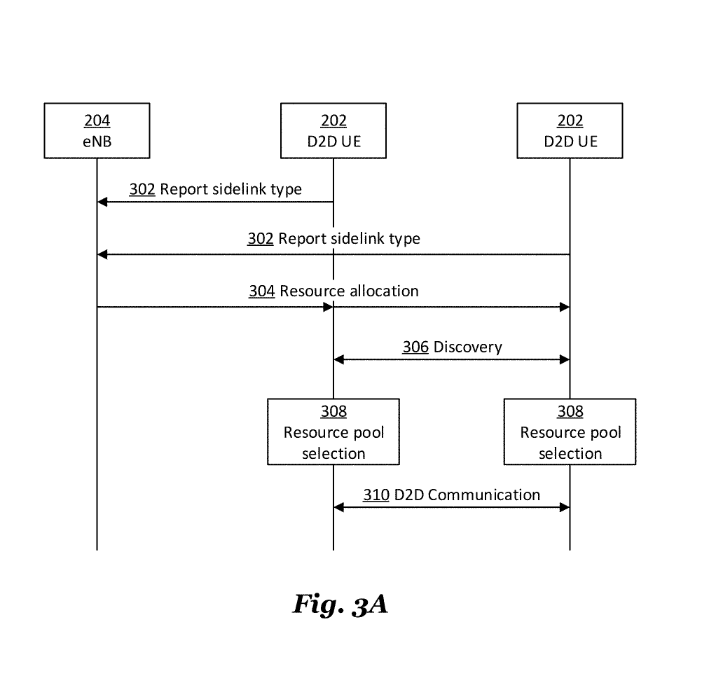

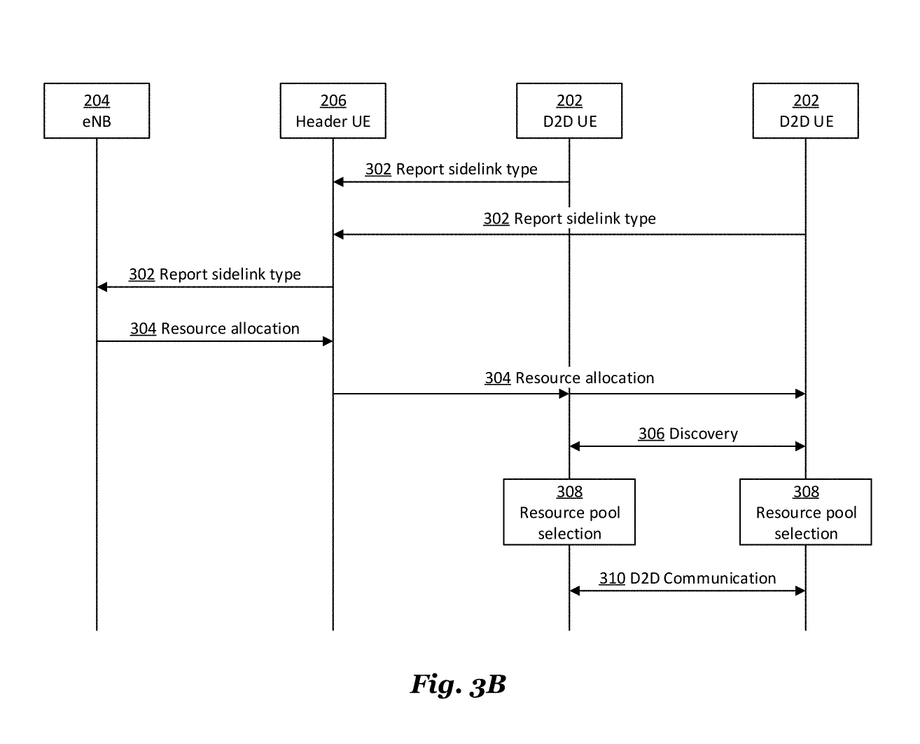

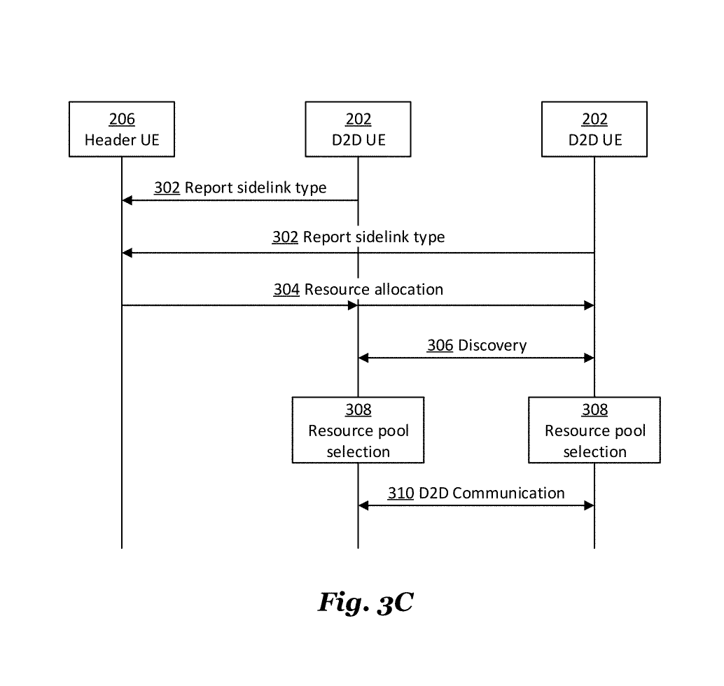

FIGS. 3A, 3B, and 3C are sequence diagrams showing D2D configuration methods. The D2D configuration methods shown in FIGS. 3A, 3B, and 3C correspond to the network scenarios shown in FIGS. 2A, 2B, and 2C, respectively. In other words, FIG. 3A shows a D2D configuration method for in-network coverage scenarios where the eNB 204 coordinates D2D communication; FIG. 3B shows a D2D configuration method for in-network coverage scenarios where the eNB 204 and the group header 206 coordinate D2D communication; and FIG. 3C shows a D2D configuration method for out-of-network coverage scenarios where the group header 206 coordinates D2D communication.

The UEs 202 report their sidelink type or capabilities (step 302). The sidelink type/capabilities may be reported directly to the eNB 204, or to the group header 206. As noted above, the sidelink type/capabilities may be communicated using a specific messaging type, and may be communicated using reserved bits of an existing channel field. In some embodiments, the UEs 202 may report their sidelink information autonomously, such as in response to a UE 202 initiating D2D communication, in response to the sidelink type changing, and the like. In some embodiments, the UEs 202 may report their sidelink information in response to the eNB 204 and/or the group header 206 periodically requesting the sidelink information from the UEs 202. The eNB 204 and/or the group header 206 collect and store information about the sidelink type/capabilities of the UEs 202.

Resource pools are allocated from an overall pool of available resources based on the sidelink types supported by the UEs 202 (step 304). A resource pool is allocated to each AI, and may be allocated by the eNB 204 and/or the group header 206. The resource pool may be allocated based on a variety of criteria, discussed below. The resources pool allocated to each AI may then be indicated to the UEs 202.

In some embodiments, the resource pools are allocated according to the sidelink types within coverage of the eNB 204 and/or the group header 206. For example, the eNB 204 and/or the group header 206 may determine that all UEs 202 in range use a certain sidelink type. The resource pool is then allocated to an air interface that uses that sidelink type. Alternatively, if more than one sidelink type is used, the resource pool may be shared between several different air interfaces corresponding to the different sidelink types. In other words, multiple resource pools may be allocated, with one resource pool allocated to each AI.

In some embodiments, the sizes of the allocated resource pools are determined according to the density of the UEs 202 in range. Resources may be divided proportionally to different Ms based on the sidelink types and densities of the UEs 202 for each sidelink type. For example, if half of the UEs 202 use a first sidelink type, and half of the UEs 202 use a second sidelink type, then the overall resource pool may be evenly divided between the UEs 202.

In some embodiments, the resource pools are allocated according to the channel resources available to the eNB 204 and/or the group header 206 in the cell. In an in-coverage scenario, the sidelink may share the resources with the cellular uplink, e.g., similar to LTE D2D in-coverage scenarios. If heavy traffic is expected in the cellular uplink, the eNB 204 may allocate limited resources to the sidelink.

In embodiments where the resource pools are allocated by the eNB 204 (e.g., FIGS. 3A and 3B), the resource pool allocation may be coordinated between several eNBs. For example, when the eNB 204 is a microcell that is part of a heterogeneous network (HetNet), the resource pool allocation may be coordinated between the eNB 204 and macro-cells in the network. In such embodiments, there may be a further relay step (not shown in Figures 3A and 3B), where the eNB 204 forwards the sidelink type/capabilities to the macro-cell and then receives resource allocations from the macro-cell.

To initiate D2D communication, a transmitting UE 202 sends a discovery signal (step 306). The sidelink type/capability of the UE 202 is indicated in the discovery signal. A receiving UE 202 receives the discovery signal and retrieves the indication of the sidelink type/capability.

The UEs 202 select resources for D2D communication from the allocated resource pools (step 308). The resources are selected based on the sidelink type/capability indicated in the discovery signal. The UEs 202 participating in the D2D communication select appropriate resources for either broadcast or unicast communication. When a UE of the UEs 202 is communicating in a broadcast manner, the transmitting UE may select the lowest sidelink type of the UEs participating in the D2D communication. The lowest sidelink type may be, e.g., a sidelink type that is the simplest sidelink type that can be supported by all of the participating UEs. The transmitting UE then chooses resources from the resource pool corresponding to an AI for the selected sidelink type. When a UE of the UEs 202 is communicating in a unicast manner, the transmitting UE may select resources from the resource pool corresponding to an AI for the receiving UE's sidelink type.

The UEs 202 may indicate the selected sidelink resources to one another during a scheduling assignment (SA) opportunity. The UEs 202 may also indicate additional information needed to communicate. For example, if the transmitting UE and the receiving UE intend to communicate using a non-orthogonal multiple access technology, then parameters such as a codebook and associated reference signals may also be indicated during the SA opportunity. The additional parameters may indicate values such as the timing adjustment, modulation and coding scheme, time resource pattern of transmission, device identifier, frequency resource indicator, frequency hopping indicator, and the like.

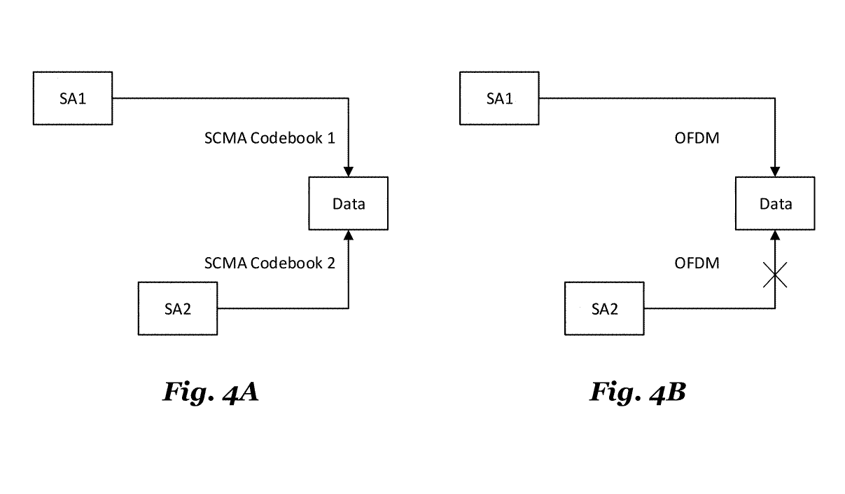

In some embodiments (not shown), the UEs 202 may be out-of-coverage of the eNB 204 and may not have a group header 206 coordinating resource allocation. In such embodiments, the transmitting UE may select resources based on the sidelink type of the receiving UE, as well as the resources indicated by other transmitting UEs in other SAs. For example, as shown in FIGS. 4A-4B, a first transmitting UE may, during a first SA (SA1), indicate first resources for a first D2D transmission; later, a second transmitting UE may first detect the resources indicated by the first transmitting UE on SAi and determine whether the same resources may be used for a second D2D transmission. In FIG. 4A, both D2D transmissions are performed using an SCMA AI. The second D2D transmission may reuse the resource with a different SCMA codebook. In FIG. 4B, OFDM is used by the first transmitting UE. The second transmitting UE selects another resource for transmission to avoid resource collision.

The transmitting UE and the receiving UE may then perform D2D communication (step 310). D2D communication is performed over the AI for the sidelink type using the resources from the selected resource pool for that AI.

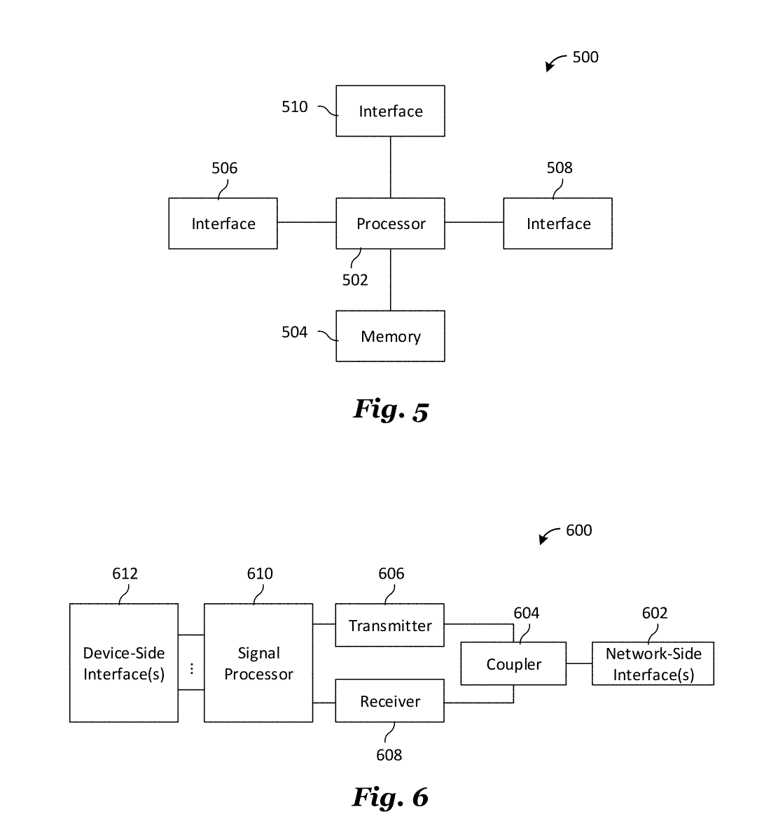

FIG. 5 illustrates a block diagram of an embodiment processing system 500 for performing methods described herein, which may be installed in a host device. As shown, the processing system 50o includes a processor 502, a memory 504, and interfaces 506-510, which may (or may not) be arranged as shown in Figure 5. The processor 502 may be any component or collection of components adapted to perform computations and/or other processing related tasks, and the memory 504 may be any component or collection of components adapted to store programming and/or instructions for execution by the processor 502. In an embodiment, the memory 504 includes a non-transitory computer readable medium. The interfaces 506, 508, 510 may be any component or collection of components that allow the processing system 500 to communicate with other devices/components and/or a user. For example, one or more of the interfaces 506, 508, 510 may be adapted to communicate data, control, or management messages from the processor 502 to applications installed on the host device and/or a remote device. As another example, one or more of the interfaces 506, 508, 510 may be adapted to allow a user or user device (e.g., personal computer (PC), etc.) to interact/communicate with the processing system 500. The processing system 500 may include additional components not depicted in FIG. 5, such as long term storage (e.g., non-volatile memory, etc.).

In some embodiments, the processing system 500 is included in a network device that is accessing, or part otherwise of, a telecommunications network. In one example, the processing system 500 is in a network-side device in a wireless or wireline telecommunications network, such as a base station, a relay station, a scheduler, a controller, a gateway, a router, an applications server, or any other device in the telecommunications network. In other embodiments, the processing system 500 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 506, 508, 510 connects the processing system 500 to a transceiver adapted to transmit and receive signaling over the telecommunications network. FIG. 6 illustrates a block diagram of a transceiver 600 adapted to transmit and receive signaling over a telecommunications network. The transceiver 600 may be installed in a host device. As shown, the transceiver 600 comprises a network-side interface 602, a coupler 604, a transmitter 606, a receiver 608, a signal processor 610, and a device-side interface 612. The network-side interface 602 may include any component or collection of components adapted to transmit or receive signaling over a wireless or wireline telecommunications network. The coupler 604 may include any component or collection of components adapted to facilitate bi-directional communication over the network-side interface 602. The transmitter 606 may include any component or collection of components (e.g., up-converter, power amplifier, etc.) adapted to convert a baseband signal into a modulated carrier signal suitable for transmission over the network-side interface 602. The receiver 608 may include any component or collection of components (e.g., down-converter, low noise amplifier, etc.) adapted to convert a carrier signal received over the network-side interface 602 into a baseband signal. The signal processor 610 may include any component or collection of components adapted to convert a baseband signal into a data signal suitable for communication over the device-side interface(s) 612, or vice-versa. The device-side interface(s) 612 may include any component or collection of components adapted to communicate data-signals between the signal processor 610 and components within the host device (e.g., the processing system 500, local area network (LAN) ports, etc.).

The transceiver 600 may transmit and receive signaling over any type of communications medium. In some embodiments, the transceiver 600 transmits and receives signaling over a wireless medium. For example, the transceiver 600 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 602 comprises one or more antenna/radiating elements. For example, the network-side interface 602 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 60o transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. Other steps may be performed by a detecting unit/module, a determining unit/module, a selecting unit/module, an indicating unit/module, a communicating unit/module, a transmitting unit/module, a receiving unit/module, an allocating unit/module, and/or a forwarding unit/module. The respective units/modules may be hardware, software, or a combination thereof. For instance, one or more of the units/modules may be an integrated circuit, such as field programmable gate arrays (FPGAs) or application-specific integrated circuits (ASICs).

Although this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method comprising:
detecting, by a transmitting user equipment (UE) of a plurality of UEs, a sidelink type of a receiving UE of the plurality of UEs, the sidelink type used by the receiving UE to communicate on a discovery channel;
determining, by the transmitting UE, a pool of resources for an air interface supported by the receiving UE and the transmitting UE;
selecting, by the transmitting UE, transmission resources from the pool of resources according to the sidelink type of the receiving UE;
indicating, by the transmitting UE, the transmission resources to the receiving UE over the discovery channel; and
communicating, by the transmitting UE, directly with the receiving UE using the transmission resources.

2. The method of claim 1, further comprising:
selecting, by the transmitting UE, the air interface.

3. The method of claim 2, wherein the air interface is selected according to a lowest sidelink type of the plurality of receiving UEs.

4. The method of claim 2, wherein the air interface is selected according to the sidelink type of the receiving UE.

5. The method of claim 1, further comprising:
indicating, by the transmitting UE, a sidelink type of each of the plurality of UEs to a group header of the plurality of UEs over the discovery channel.

6. The method of claim 5, wherein the pool of resources is determined by the group header according to the sidelink type of each of the plurality of UEs.

7. The method of claim 1, further comprising:
indicating, by the transmitting UE, a sidelink type of each of the plurality of UEs to an enhanced base station (eNB) over a radio resource control interface.

8. The method of claim 7, wherein the pool of resources is determined by the eNB according to the sidelink type of each of the plurality of UEs.

9. A method comprising:
receiving, by a first enhanced base station (eNB), an indicator of a sidelink type for each of a plurality of user equipments (UEs) within range of the first eNB;
determining, by the first eNB, a density of the plurality of UEs; and
allocating, by the first eNB, one or more resource pools corresponding to air interfaces supported by the plurality of UEs, the one or more resource pools allocated according to the sidelink type of each of the plurality of UEs and the density of the plurality of UEs.

10. The method of claim 9, wherein receiving the indicator of the sidelink type for each of the plurality of UEs comprises receiving the indicator from each of the plurality of UEs on a discovery channel.

11. The method of claim 9, wherein receiving the indicator of the sidelink type for each of the plurality of UEs comprises receiving the indicator of each of the plurality of UEs from a first UE of the plurality of UEs over a radio resource control interface.

12. The method of claim 9, further comprising:
transmitting, by the first eNB, a request to each of the plurality of UEs, each indicator of the sidelink type of the plurality of UEs transmitted to the first eNB in response to the request.

13. The method of claim 9, wherein the indicator of the sidelink type of a first UE of the plurality of UEs is received in response to the first UE requesting configuration for a device-to-device (D2D) transmission.

14. The method of claim 9, further comprising:
forwarding, by the first eNB, the indicator of the sidelink type for each of the plurality of UEs to a second eNB; and
receiving, by the first eNB, indicators of the one or more resource pools from the second eNB.

15. The method of claim 14, wherein the one or more resource pools allocated by the first eNB are subsets of one or more second resource pools allocated by the second eNB.

16. A transmitting user equipment (UE) comprising:
a processor; and
a computer readable storage medium storing programming for execution by the processor, the programming including instructions to:
detect a sidelink type of a receiving UE of a plurality of UEs, the sidelink type used by the receiving UE to communicate on a discovery channel;
determine a pool of resources for an air interface supported by the receiving UE and the transmitting UE;
select transmission resources from the pool of resources according to the sidelink type of the receiving UE;
indicate the transmission resources to the receiving UE over the discovery channel; and
communicate directly with the receiving UE using the transmission resources.

17. The transmitting UE of claim 16, the programming further including instructions to:
select the air interface according to a lowest sidelink type of the plurality of UEs.

18. The transmitting UE of claim 16, the programming further including instructions to:
select the air interface according to the sidelink type of the receiving UE.

19. An enhanced base station (eNB)comprising:
a processor; and
a computer readable storage medium storing programming for execution by the processor, the programming including instructions to:
receive an indicator of a sidelink type for each of a plurality of user equipments (UEs) within range of the eNB;
determine a density of the plurality of UEs; and
allocate one or more resource pools corresponding to air interfaces supported by the plurality of UEs, the one or more resource pools allocated according to the sidelink type of each of the plurality of UEs and the density of the plurality of UEs.

20. The eNB of claim 19, wherein the instruction to receive the indicator of the sidelink type for each of the plurality of UEs comprises instructions to:
receive the indicator from each of the plurality of UEs on a discovery channel.

21. The eNB of claim 19, wherein the instruction to receive the indicator of the sidelink type for each of the plurality of UEs comprises instructions to:
receive the indicator of each of the plurality of UEs from a first UE of the plurality of UEs over a radio resource control interface.
